(19) United States
(12) Patent Application Publication
(10) Pub. No.: US 2021/0285787 A1
(43) Pub. Date: Sep. 16, 2021

(54) ESTIMATING ALTERNATIVE FUEL BENEFITS IN A FLEET OF VEHICLES

(71) Applicant: Mikhail ALEKSEENKO, Houston, TX (US)

(72) Inventor: Mikhail ALEKSEENKO, Houston, TX (US)

(21) Appl. No.: 17/286,277

(22) PCT Filed: Oct. 18, 2019
(86) PCT No.: PCT/US2019/056958

§ 371 Date: Apr. 16, 2021

Related U.S. Application Data
(60) Provisional application No. 62/747,556, filed on Oct. 18, 2018.

(51) Int. Cl. G01C 21/36; G01C 21/34; G01C 21/32

(52) U.S. Cl. CPC G01C 21/3682; G01C 21/3469; G01C 21/3617; G01C 21/343; G01C 21/32

(57) ABSTRACT

The present technology discloses a method for tracking and estimating alternative fuel benefits. This method is achieved by receiving, from at least one alternative fuel capable vehicle, a set of vehicle-specific data; aggregating the at least one set of vehicle-specific data into a fleet dataset; receiving a traditional fuel dataset, an alternative fuel dataset, a conversion dataset, and auxiliary datasets; optimizing, using the fleet dataset, the traditional fuel dataset, the alternative fuel dataset, the conversion dataset, and auxiliary datasets, fuel consumption practices for the at least one alternative fuel capable vehicle, the fuel consumption practices comprising vehicle routes, vehicle conversions, or fueling stops; and recommending the fuel consumption practices.

### CROSS-REFERENCE TO RELATED APPLICATION

This application is related to and claims priority under 35 U.S.C. § 119(e) from U.S. Patent Application No. 62/747,556, filed Oct. 18, 2019 entitled “ESTIMATING ALTERNATIVE FUEL BENEFITS IN A FLEET OF VEHICLES,” the entire contents of which is incorporated herein by reference for all purposes.

### FIELD OF THE INVENTION

The present technology discloses a system and method for tracking and estimating alternative fuel benefits in a fleet of vehicles.

### BACKGROUND OF THE INVENTION

Generally, vehicles operate on one type of fuel, namely traditional fuel (e.g., gasoline or diesel). Some vehicles can operate on alternative type fuels (e.g., CNG, LNG, RNG, propane, dual-fuel (CNG/diesel or CNG/gasoline), ethanol, biodiesel, renewable diesel, hydrogen, PEV, electric, etc.). Switching a vehicle fuel type from a traditional fuel to an alternative fuel or purchasing an alternative fuel vehicle (switch to alternative fuels) can lead to: (1) reduced fuel and maintenance costs; and (2) lower CO₂ and NOx emissions. However, switching from traditional fuels to alternative fuels may not be feasible for every vehicle due to: (1) significant upfront or leasing costs; and (2) relatively immature infrastructure.

As such, fleet vehicles with a home base (e.g., refuse centers, transit hubs, school buses, etc.) are likely candidates to switch to alternative fuels, as the fleet vehicles can benefit from a steady fuel demand profile (which allows optimization of costs related to a switch to alternative fuels) and the ability to “slow-fill” rather than “fast-fill” (which reduces fueling infrastructure costs).

Alternative fuel vehicles or dual-fuel vehicles have been slow to penetrate the market and currently comprise a small percentage of vehicles on U.S. roads. In order for more vehicles to switch to alternative fuels, there is a need for accurate and reliable estimation of potential alternative fuel benefits and/or tracking realized alternative fuel benefits. Such systems and methods can provide data-driven, transparent, and efficient ways for potential or actual alternative fuel vehicle owners to estimate economic and/or environmental benefits of a switch to alternative fuel, thus accelerating the transition of the U.S. transportation sector to economically viable or sustainable fuels.

### SUMMARY OF THE INVENTION

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer readable media for tracking and estimating alternative fuel benefits in a fleet of vehicles that include data warehouses configured to store or access vehicle geospatial data (e.g. GPS, ELD, apps, etc.), vehicle operating parameters (e.g. speed, engine status, fuel consumption, etc.), vehicle information (engine type, fuel type, brand, mileage, etc.), traditional-fuel data (geospatial data of fueling stations, historical fuel costs, fuel efficiency, etc.), alternative-fuel data (geospatial data of fueling stations, historical fuel costs, relative efficiency vs. traditional fuel, etc.), conversion data (outfitter conversion costs associated with various alternative fuel types, manufacturer costs associated with various alternative fuel types, fuel tank sizes, etc.), and auxiliary data (customer-specific data, locale-specific data, road inclination, road surfaces, road conditions, weather patterns, fuel price projections, etc.).

The systems, methods, and non-transitory computer readable media for tracking and estimating alternative fuel benefits in a fleet of vehicles can also include a central station that is linked to the data warehouse that is configured to store algorithms for analysis of the data and process and analyze that data using algorithms to find optimal fuel consumption practices.

The systems, methods, and non-transitory computer readable media for tracking and estimating alternative fuel benefits in a fleet of vehicles can also include fleet manager interfaces linked to the central station. These interfaces can be configured to, for example and without imputing limitation, access, evaluate, and further process estimates of potential and/or realized alternative fuel benefits, conduct “what-if” and sensitivity analyses including adjusted routes, adjusted fill infrastructure, adjusted conversion costs, and adjusted fuel prices, and to enable communication with individual vehicles with suggestions for optimization of alternative-fuel cost-savings and/or alternative-fuel emission reduction.

### DESCRIPTION OF DRAWINGS

In order to describe the manner in which the above recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a flow diagram for an example method for tracking and estimating alternative fuel benefits in a fleet of vehicles, or for optimizing alternative-fueling infrastructure using an embodiment of the present invention;

FIG. 2 is a schematic diagram of an example system for tracking and estimating alternative fuel benefits in a fleet of vehicles or for optimizing alternative-fueling infrastructure using an embodiment of the present invention;

FIG. 3 is a schematic diagram of an example system for tracking and estimating alternative fuel benefits in a fleet of vehicles or for optimizing alternative-fueling infrastructure using an embodiment of the present invention;

FIG. 4 is a schematic diagram of an example system for tracking and estimating alternative fuel benefits in a fleet of vehicles or optimizing alternative-fueling infrastructure using an embodiment of the present invention;

FIG. 5 illustrates an example computing device in accordance with some embodiments of the present technology; and

FIG. 6 illustrates an example computing device in accordance with some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Moreover, it should be understood that features or configurations herein with reference to one embodiment or example can be implemented in, or combined with, other embodiments or examples herein. That is, terms such as “embodiment”, “variation”, “aspect”, “example”, “configuration”, “implementation”, “case”, and any other terms which may connote an embodiment, as used herein to describe specific features or configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

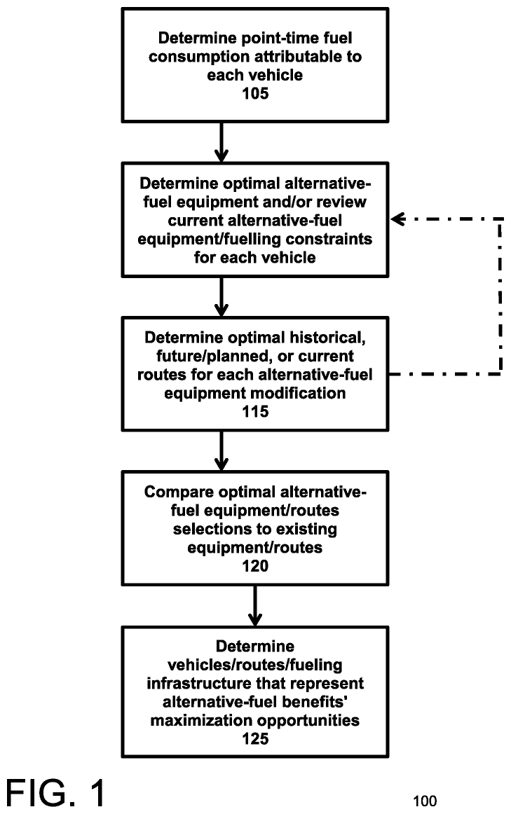

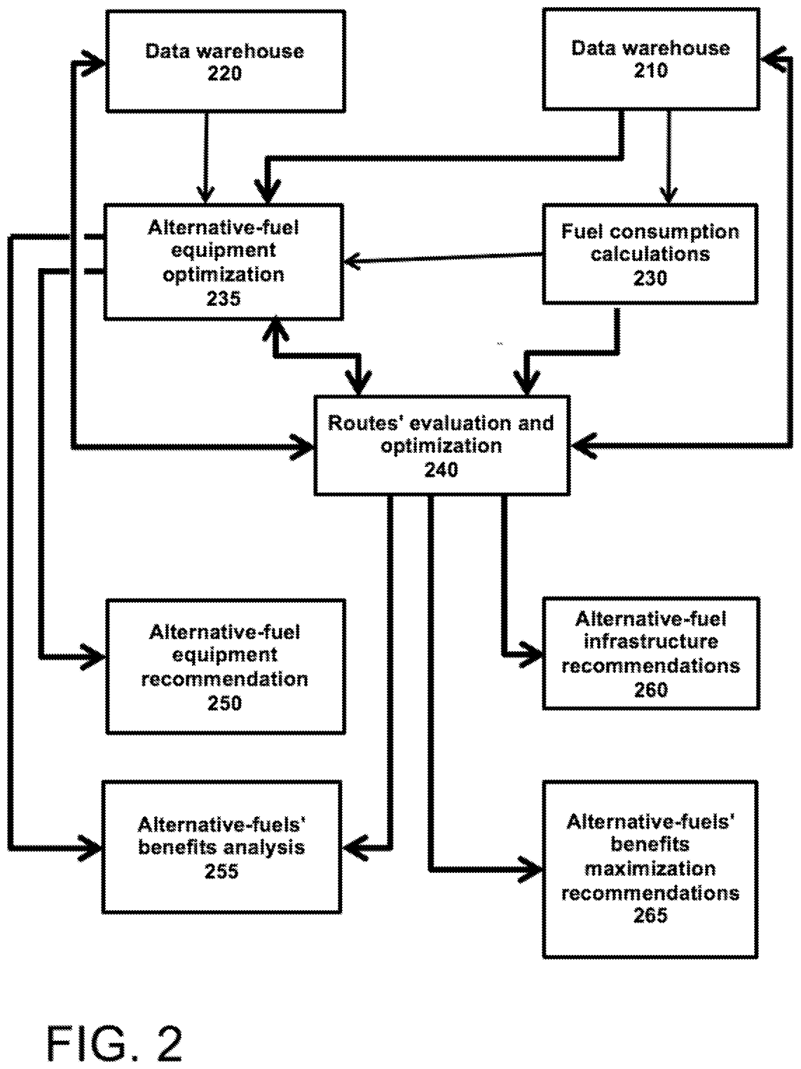

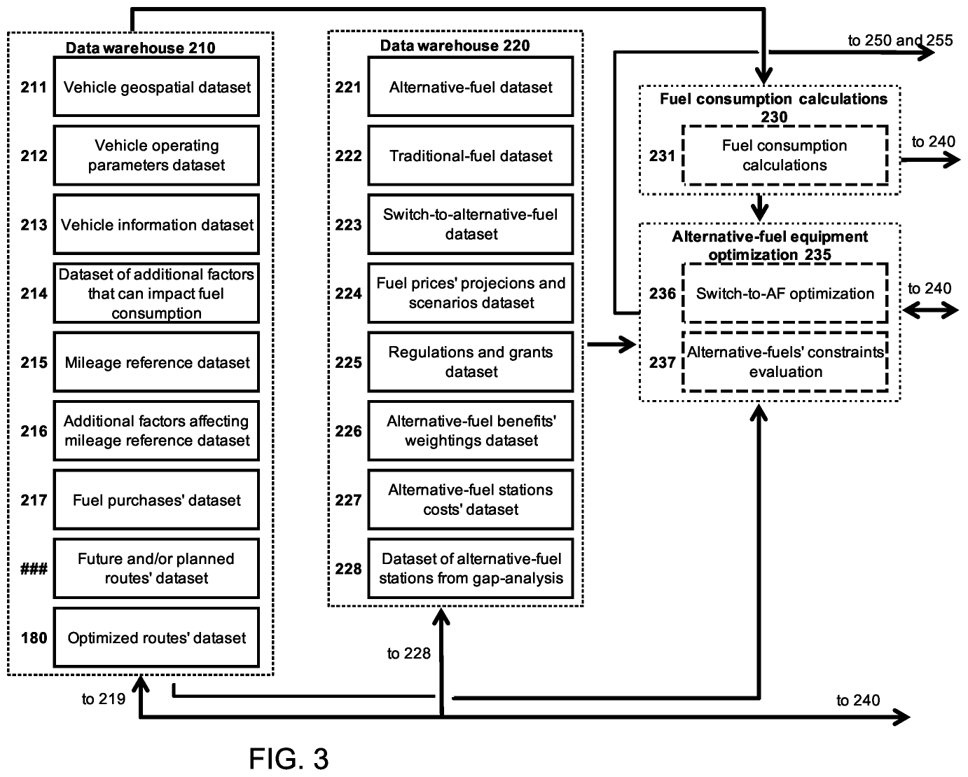

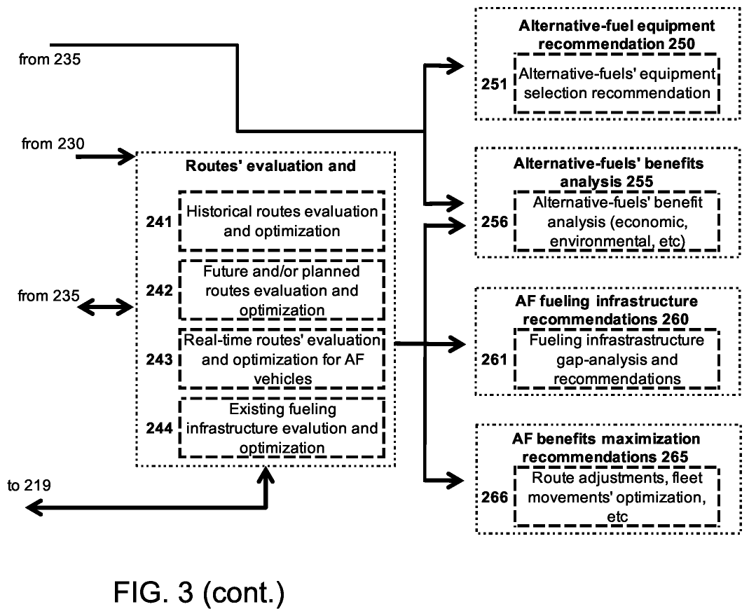

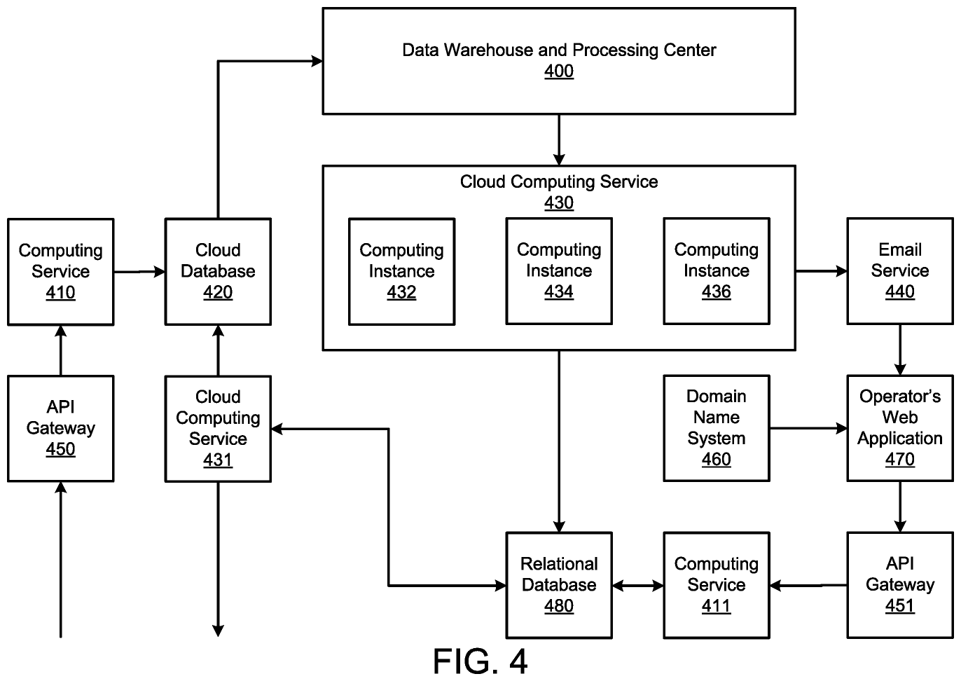

The disclosed technology addresses the need in the art for tracking and estimating alternative fuel benefits in a fleet of vehicles. Disclosed are systems, methods, and computer-readable storage media for tracking and estimating alternative fuel benefits in a fleet of vehicles or for optimizing alternative-fueling infrastructure. A discussion of an example of this technology is first disclosed herein. A discussion of schematics of an example system as illustrated in FIGS. 2 and 3 will then follow. The discussion then concludes with a description of example devices, as illustrated in FIG. 4. These variations shall be described herein as the various embodiments are set forth. The disclosure now turns to FIG. 1.

FIG. 1 is a flow chart of an example method for tracking and estimating alternative fuel benefits (e.g., cost savings and/or emissions' reduction associated with a switch to alternative fuel) in a fleet of vehicles or for optimizing alternative-fueling infrastructure. Method 100 illustrated in FIG. 1 is provided by way of example, as there are a variety of ways to carry out the method. Additionally, while the example method is illustrated with a particular order of blocks, those of ordinary skill in the art will appreciate that FIG. 1 and the steps illustrated therein can be executed in any order that accomplishes the technical advantages of the present disclosure and can include fewer or more steps than illustrated.

Each block shown in FIG. 1 represents one or more processes, methods, or subroutines, carried out in the example method. The blocks illustrated in FIG. 1 can at least be implemented in the systems illustrated in FIGS. 2-4. Additional steps or fewer steps are possible to complete the example method. Each block shown in FIG. 1 can be carried out by at least a system illustrated in FIGS. 2-4.

Method 100 can begin at block 105. At block 105, a point-time fuel consumption of a vehicle can be determined. For example, geospatial data of a vehicle can be coupled with vehicle and engine characteristics, vehicle operating conditions, traffic patterns, road conditions, or other factors to estimate fuel consumption at one or more points in space and time (e.g., predetermined intervals, user defined intervals, etc.). In some examples, the vehicle can be one of a fleet of vehicles, and each vehicle in the fleet of vehicles can have the point-time fuel consumption determined. For example, a vehicle's general fuel consumption can be determined by the common vehicle characteristics (e.g., engine, size, weight, etc.) and the estimated travel speed (e.g., geospatial data). The fuel consumption can be increased or decreased by operating conditions, weather, location, road conditions (e.g., pitch) to determine the point-time fuel consumption for the vehicle. In these calculations, larger weighting (e.g., 60-80%) can be assigned to common vehicle characteristics and the estimated travel speed. Other factors, such as operating (e.g. stop-and-go traffic or steady velocity) and road conditions (e.g., pitch), weather, or altitude, among other factors, can be given a lesser weighting compared to the common vehicle characteristics (e.g., 20-40%).

Road and vehicle characteristics can be retrieved in a variety of different manners, including manual recording of data into a database (for vehicle-specific information), querying public APIs (for weather and road conditions), or by using other wireless transmission protocols, for example.

At block 110, a configuration can be determined for the vehicle and/or fleet of vehicles. In some examples, the configuration can be an optimal alternative fuel equipment configuration. For example, based on existing alternative fuel fill infrastructure a large alternative fuel fuel-tank system may be required in order for a vehicle to utilize alternative fuels at a threshold amount (e.g., all the time, part-time, etc.). In those cases, an algorithm can run cost-benefit analysis of installing a large system and compare it to cost-benefits of a less-than-threshold utilization of an alternative fuel equipment configuration. In some examples, the configuration can be to review a current alternative fuel equipment configuration (or constraints) and determine an updated optimal configuration. Such determinations can be made by analyzing various datasets. For example, by using information about vehicle's point-time fuel consumption as determined in block 105, dataset of possible alternative fuel equipment configurations, and geospatial data of alternative fuel fueling stations, one can determine whether a certain alternative fuel equipment configuration can be sufficient to achieve an alternative fuel equipment utilization rate threshold. In some examples, the threshold can be 100%. In cases where alternative fuel utilization rate for a certain alternative fuel equipment configuration is below the threshold, an alternative scenario can be run, determining minimal (e.g., lowest tank size and lowest cost) alternative fuel equipment configuration, at which alternative fuel equipment utilization rate reaches or approaches the threshold. Alternative fuel equipment configuration and alternative fuel utilization scenarios for each vehicle can be stored for future analysis.

At block 115, alternate routes can be determined. For example, in a case where alternative fuel fill infrastructure is not sufficient along a planned route, an algorithm will propose an alternative route where such fill infrastructure is present. In some examples, historical routes (e.g., optimal routes, non-optimal routes, etc.), future routes (e.g., planned, potential), or current routes for each vehicle can be used to determine the alternate alternative fuel vehicle routes. In some examples, the determined routes can be based on the configuration and potential routes for fueling up the alternative fuel vehicles from historical destinations. For example, if alternative fuel utilization rate for a route is below the threshold, alternate routes from start point to end point can be proposed and examined, in search of a route with a higher alternative fuel utilization rate. Estimated travel times, distance, fuel consumption data, fuel costs, and other information related to the alternate routes can be stored for future analysis and comparison to historical routes.

At block 120, alternate routes can be compared to historical traditional vehicle routes. For example, travel times and approximate fueling costs of alternative fuel vehicles can be compared to originally planned or historical routes. In some examples, a vehicle's historical routes from point A to point B can be compared to the alternate routes to determine potential benefits/pitfalls of conversion of a vehicle with an alternative fuel system. For example, if historical traditional vehicle routes result in alternative fuel utilization rate below the threshold and alternate routes with higher utilization rates have been determined in block 115, a comparison of key metrics (e.g., estimated travel times, distance, fuel consumption data, fuel costs) between alternate and historical routes can be performed.

At block 125, a determination can be made for maximization of opportunities based on the alternative vehicles, routes, and current infrastructure (e.g., alternative fueling stations). For example, large alternative fuel tanks or longer alternative vehicle routes can indicate that infrastructure is lagging: subsequently, alternative fuel stations' locations can be simulated and scenarios can be run as if those stations are already present. In some examples, data obtained from blocks 110, 115, and 120 (e.g., scenarios of various alternative fuel equipment configurations, alternate routes, and key metrics) can be compiled into various scenarios, which can be subsequently analyzed and optimized (e.g., using machine learning algorithms, Monte Carlo simulations, etc.).

The disclosure now turns to FIG. 2, a schematic diagram of an example system for tracking and estimating alternative fuel benefits in a fleet of vehicles or for optimizing alternative-fueling infrastructure

Data warehouse 210 can house information used to capture or estimate vehicle fuel consumption, including but not limited to: geospatial dataset 211 (e.g., point-time data from GPS, third party apps, electronic logging devices, etc.); vehicle operating parameters dataset 212 (e.g., point-time data that pertains to vehicle operating parameters, included but not limited to speed, tire pressure, engine status, fuel consumption, etc.); vehicle information dataset 213 (e.g., information about vehicle, including but not limited to make, model, year, engine type, weight, fuel-type, range, etc.); dataset of additional factors that can impact fuel consumption 214 (e.g., dataset with miscellaneous information that can affect fuel consumption rate, including but not limited to road conditions, traffic patterns, weather conditions, etc.); mileage reference dataset 215 (e.g., dataset that includes relationships between fuel consumption and known vehicle operating parameters, geospatial data (i.e. slope of the road), or vehicle information, etc.); additional factors affecting mileage reference dataset 216 (e.g., dataset that includes relationships between fuel consumption and additional factors, etc.); fuel purchases' dataset 217 (e.g., dataset that includes point-time data about fuel purchases made, including but not limited to volume, type, costs, etc.); future or planned routes' dataset 218 (e.g., dataset that includes point-time information about future or planned routes, when available—when future or planned routes' information is unavailable, historical data can be used to approximate future driving patterns, etc.); optimized routes' dataset 219 (e.g., dataset that includes point-time information of optimized routes, etc.). Datasets within this warehouse can be more or less relevant depending on the calculations being performed. In some instances, certain datasets can have a larger weight than others. In other instances, those same certain datasets can have less weight than the others. This is not meant to be limiting, but merely illustrative of datasets having different weights in different instances. For example, geospatial dataset 211 and vehicle information dataset 213 are the primary datasets for determining fuel consumption and can be weighted higher than others (e.g., 60-80%) would be when making these calculations. Other datasets can be weighted less and may be forgone completely in the calculations, especially if such data is not available for a vehicle.

Data warehouse 220 can house information in conjunction with Data warehouse 210 for estimating potential or tracking realized alternative fuel utilization rates (e.g., percentage of time when alternative-fuels can be used due to regulatory, infrastructure, and/or other constraints) or alternative fuel benefits. It can also be used to evaluate the need for additional alternative fuel fueling infrastructure. Data warehouse 220 can include, but is not limited to: alternative-fuel dataset 221 (e.g., dataset that includes information about alternative-fuel stations, including but not limited to types and volumes of fuel available, prices, location, or emissions data); traditional-fuel dataset 222 (e.g., dataset that includes information about traditional-fuel stations, including but not limited to types and volumes of fuel available, prices, location, or emissions data); conversion dataset 223 (e.g., dataset that includes information about switch to alternative-fuel options, including but not limited to types, costs, and ranges of equipment available, costs of various equipment, information matching vehicle information (make, model, year, engine, etc.) to various equipment options, information about alternative-fuel equipment manufacturers and installers, etc.); fuel prices' projections and scenarios dataset 224 (e.g., dataset that includes generic or vehicle owner's specific scenarios for location-specific price projections for alternative- and traditional-fuels); regulations and grants dataset 225 (e.g., dataset that includes information about existing, planned, potential, or upcoming location-specific regulations and grants pertaining to alternative- and traditional-fuels, vehicles, and vehicles' adjustments); alternative-fuel benefits' weightings 226 (e.g., dataset that includes location-specific generic or vehicle owner's location-specific alternative-fuel benefits' weightings, including but not limited to fuel costs, maintenance costs, CO₂ emissions, NOx emissions, sulfur content, fuel type, etc.); alternative-fuel stations costs' dataset 227 (e.g., dataset that includes cost estimates of various alternative-fuel stations, as a function of including but not limited to fuel-type, location (e.g. country or state), capacity (e.g. vehicle or volume through-put per day, etc.); and dataset of alternative-fuel stations from gap-analysis 228 (e.g., dataset that includes locations of alternative-fuel stations). Some of the datasets within this warehouse can have a larger weight than others, and vice versa as described above. For example, alternative-fuel dataset 221, traditional-fuel dataset 222, and conversion dataset 223 are the primary datasets for determining cost benefits of a switch to alternative fuel and will be weighted higher than others (e.g., 40-80%). Other datasets will be weighted less, but, depending on vehicle owners' preferences toward maximizing costs or environmental benefits, their weightings may fluctuate. Further, some vehicle owners may have strong views about fuel prices' projections. If those views differ dramatically from historical fuel prices, weighting of fuel prices' projections and scenarios dataset 224 may increase. In some instances, weights can be user-defined or configurable.

Fuel consumption calculations 230 can house an algorithm 231 that outputs point-time fuel-consumption data based on data from Data warehouse 210. For example, geospatial data of a vehicle will be coupled with vehicle and engine characteristics, vehicle operating conditions, traffic patterns, road conditions, or other factors to estimate fuel consumption at one or more points in space and time. When point-time fuel consumption data is available as part of vehicle operating parameters dataset 212, this can serve as the pass-through system for such data. As described earlier, fuel consumption of a vehicle can be determined by the common vehicle characteristics (e.g., engine, size, weight, etc.) and the estimated travel speed (geospatial data). The fuel consumption can be increased or decreased by operating conditions, weather, location, or road conditions (e.g., pitch) to determine the point-time fuel consumption for the vehicle. In these calculations, larger weighting (e.g., 60-80%) will be assigned to the common vehicle characteristics and the estimated travel speed. Other factors, such as operation status (e.g., stop-and-go traffic or steady velocity) and road conditions (e.g., pitch), weather, or altitude will be given a lesser weighting (e.g., 20-40%).

Alternative-fuel equipment optimization 235 can house algorithms (236 and 237) to optimize alternative-fuel equipment selection and evaluate alternative-fuel infrastructure based on the datasets (e.g., Data warehouses 210 and 220) and outputs of Fuel consumption calculations 230. Conversion optimization 236 can be an algorithm that optimizes alternative-fuel equipment selection (conversion to alternative-fuel, re-power to alternative-fuel, or purchase of an alternative-fuel vehicle) based on the datasets (e.g., Data warehouses 210 and 220) and outputs of Fuel consumption calculations 230. As described earlier, such determinations can be made by analyzing various datasets. For example, by using information about vehicle's point-time fuel consumption as determined in block 105 and data from data warehouse 220, one can determine whether a certain alternative fuel equipment configuration will be sufficient to achieve alternative fuel equipment utilization rate of the threshold. In cases where alternative fuel utilization rate for a certain alternative fuel equipment configuration is below the threshold, an alternative scenario can be run, determining minimal (e.g. lowest tank size and lowest cost) alternative fuel equipment configuration, at which alternative fuel equipment utilization rate reaches or approaches the threshold. Alternative fuel equipment configuration and alternative fuel utilization scenarios for each vehicle can then be stored for future analysis. In some examples, the algorithm 236 can work in conjunction with the output from Routes' evaluation and optimization 240. Alternative-fuels' constraints evaluation 237 can be an algorithm that evaluates constraints of alternative-fuel fueling infrastructure based on datasets (e.g., Data warehouses 210, 220) and outputs of Fuel consumption calculations 230; the algorithm outputs locations and specifications of alternative-fueling stations that may improve alternative-fuel utilization rate among evaluated vehicles. For example, if results of the algorithms 236, 237 indicate that in order to maximize alternative fuel utilization rate a large alternative fuel tank size is required, it may be an indication of a lagging alternative fuel fueling infrastructure. In such an example, the algorithms 236, 237 can work in the conjunction with the output from Routes' evaluation and optimization 240.

Routes' evaluation and optimization 240 can house algorithms (241, 242, 243, 244) to optimize historical, future, and/or planned routes and/or make near-real-time route suggestions for alternative-fuel vehicles based on the datasets (e.g., Data warehouses 210, 220) and outputs of Fuel consumption calculations 230 and Alternative-fuel equipment optimization 235. The outputs of the algorithms (241, 242, 243, 244) housed in routes' evaluation and optimization 240 can be fed back alternative-fuel equipment optimization 235 to determine if solutions obtained with 240 can resolve alternative-fuels' constraints or improve switch-to-AF optimization. Such outputs from routes' evaluation and optimization 240 can lead to generation of additional scenarios within alternative fuel equipment optimization 235, which can be subsequently fed back to routes' evaluation and optimization 240 until a stable, thus optimum, solution is found.

Historical routes' evaluation and optimization algorithm 241 can be an algorithm that evaluates, optimizes, and captures potential or realized alternative-fuel benefits based on the datasets (e.g., Data warehouses 210, 220) and outputs of Fuel consumption calculations 230 and Alternative-fuel equipment optimization 235. For example, vehicle geospatial dataset 211, traditional fuel dataset 222, and fuel consumption calculations 230 can be used to evaluate whether the routes taken in the past were efficient. In cases where better routes (e.g., faster travel times or lower fuel consumption) are found, those better routes are stored as a benchmark to be used against any alternative fuel routes. Regardless of the better routes, key metrics attributed to all routes are calculated and captured (e.g. waypoints, travel times, fuel consumption, fuel costs, distances between fueling stations, emissions, etc.). Similar calculations will be made using alternative fuel equipment configurations output by algorithm 236 together with vehicle geospatial dataset 211, alternative-fuel dataset 221, dataset of alternative-fuel stations from gap analysis 228, and other datasets from data warehouses 210 and 220. Similar to evaluation of traditional fuel routes, key metrics for alternative fuel routes are calculated and captured (e.g. waypoints, travel times, fuel consumption, fuel costs, distances between fueling stations, emissions, etc.).

Future or planned routes' evaluation and optimization algorithm 242 can be an algorithm that evaluates, optimizes, and captures potential or realized alternative-fuel benefits based on the datasets (e.g., Data warehouses 210, 220) and outputs of Fuel consumption calculations 230 and Alternative-fuel equipment optimization 235. Algorithm 242 can work in a very similar way to the historical routes' evaluation 241 with the exception that instead of vehicle geospatial dataset 211, future or planned routes' dataset 218 is being used. Namely, for example, future or planned routes' dataset 218, traditional fuel dataset 222, and fuel consumption calculations 230 can be used to evaluate whether the routes taken in the past were efficient. In cases where better routes (e.g., faster travel times or lower fuel consumption) are found, those routes are stored in future or planned routes' dataset 218 as a benchmark to be used against any alternative fuel routes. Future or planned routes can also be manually entered into this dataset for later evaluation, or automatically generated using geospatial data, along with other factors. Regardless of whether better routes are found or not, key metrics attributed to all routes are calculated and captured (e.g. waypoints, travel times, fuel consumption, fuel costs, distances between fueling stations, emissions, etc.). Similar calculations will be made using alternative fuel equipment configuration(s) outputted by algorithm 236 together with future and/or planned routes' dataset 218, alternative-fuel dataset 221, dataset of alternative-fuel stations from gap analysis 228, and other datasets from data warehouses 210 and 220. Similarly to evaluation of traditional fuel routes, key metrics for alternative fuel routes are calculated and captured (e.g. waypoints, travel times, fuel consumption, fuel costs, distances between fueling stations, emissions, etc.).

Real-time routes' evaluation and optimization for alternative fuel vehicles' algorithm 243 can be an algorithm that evaluates and optimizes potential routes in real-time based on datasets (e.g., Data warehouses 210, 220) and outputs of Fuel consumption calculations 230. Algorithm 243 can use alternative fuel equipment configurations output by algorithm 236 together with vehicle geospatial dataset 211 streamed in real- or near-real-time, vehicle operating parameters dataset 212, fuel purchases dataset 217, alternative-fuel dataset 221, dataset of alternative-fuel stations from gap analysis 228, and other datasets from data warehouses 210 and 220. Based on aforementioned datasets and outputs, algorithm 243 can calculate a remaining alternative fuel range of a vehicle and optimize fueling program along the proposed route. Algorithm 243 can be further aided by installation of a sensor in a vehicle's alternative fuel tank, thus allowing direct measurement rather than estimation of the remaining alternative fuel and alternative fuel range.

Existing fueling infrastructure evaluation and optimization algorithm 244 can be an algorithm that evaluates and optimizes alternative-fuel infrastructure based on the datasets (e.g., Data warehouses 210, 220) and outputs of Fuel consumption calculations 230 and Alternative-fuel equipment optimization 235. For example, outputs of alternative-fuel equipment optimization 235, namely, alternative fuel equipment configurations and alternative fuel utilization scenarios for each vehicle, plus sections in vehicle routes where alternative fuel utilization drops below the threshold can be found. Algorithm 244 can then create proposals for alternative fuel stations' locations along vehicle routes in such a way as to raise fuel utilization closer to or to the threshold. Locations of proposed alternative fuel stations are then stored in dataset of alternative-fuel stations from gap-analysis 228 for subsequent use.

Alternative-fuel equipment recommendation 251 can house an algorithm 251 to aggregate and present solutions pertaining to alternative-fuel equipment selections solved for by algorithms of Alternative-fuel equipment optimization 235. For example, outputs from conversion optimization algorithm 236, namely alternative fuel equipment configuration and alternative fuel utilization scenarios, can be aggregated, and readied for display on communication interface 440.

Alternative-fuels' benefit analysis 255 can house an algorithm 256 to aggregate and present solutions pertaining to alternative-fuel benefits (economic, environmental, etc.) solved for by algorithms of Alternative-fuel equipment optimization 235 and Routes' evaluation and optimization 240. For example, alternative fuel equipment configuration and associated parameters (utilization rate, equipment specifications, equipment costs, fuel costs, etc.) from alternative-fuel equipment optimization 235 and key metrics related to routes (e.g. waypoints, travel times, fuel consumption, fuel costs, distances between fueling stations, emissions, etc.) from routes' evaluation and optimization 240 can be analyzed together to calculate and summarize key alternative-fuel benefits (e.g. net present value of a conversion, estimated reduction in fuel spending, estimated increase or decrease in travel times or distances, amount of emissions reduction (CO₂, NOx, etc.), estimated reduction in maintenance costs, etc.). These key metrics can then be readied by the algorithm 256 for display on communication interface 440.

Alternative fueling infrastructure recommendations 260 can house an algorithm 261 to aggregate and present solutions pertaining to gaps and opportunities in alternative-fuel fueling infrastructure solved for by algorithms of Routes' evaluation and optimization 240. For example, when routes' evaluation and optimization 240 captures indicators of a lagging infrastructure, such indicators (e.g. sections of routes on which alternative fuels' utilization rate drops below the threshold, locations of proposed alternative-fuel stations from gap analysis, etc.) can be aggregated and readied for display on communication interface 440. If routes' evaluation and optimization 240 indicates that infrastructure is sufficient to achieve threshold alternative fuels' utilization rate, such a finding can also be readied for display on communication interface 440.

Alternative fuel benefits maximization recommendations 265 can house an algorithm 266 to aggregate and present solutions pertaining to opportunities in maximizing alternative-fuel benefits via route adjustments, fleet movements' optimization, or other means solved for by algorithms of Routes' evaluation and optimization 240. For example, outputs from future or planned routes' evaluation and optimization algorithm 242 (e.g. waypoints, travel times, fuel consumption, fuel costs, distances between fueling stations, emissions, etc.), particularly key metrics of alternate alternative fuel routes, can be aggregated and readied for a side-by-side display with other scenarios on communication interface 440.

Examples of tracking and estimating alternative fuel benefits in a fleet of vehicles or for optimizing alternative-fueling infrastructure from the use of this invention are given below. These examples are not exhaustive and are meant to demonstrate embodiments of the invention. Other uses of this invention can be encompassed.

Consider the case of irregular fuel consumption due to traffic conditions. Truck 1 drives a daily route from point A to point B. The only alternative-fuel stations along the route are located at end-points, point A and point B. Because of an irregular traffic pattern along the route, its one-way fuel consumption varies greatly and amounts to 0.7× to 1.3× that of an alternative fuel capacity. With average fuel consumption being close to 1× that of an alternative fuel capacity, prior art system and methods would lead to incorrect input parameters for a feasibility evaluation of a switch to alternative fuel.

Consider the case of irregular fuel consumption due to road sloping. Truck 2 drives a daily route from point A to point B. The only alternative-fuel stations along the route are located at end-points, point A and point B. Because of significant road sloping along the route, its one-way fuel consumption varies greatly and amounts to 0.7× to 1.3× that of an alternative fuel capacity. With average fuel consumption being close to 1× that of an alternative fuel capacity, prior art system and methods would lead to incorrect input parameters for a feasibility evaluation of a switch to alternative fuel.

Consider the case of irregular fuel consumption due to load changes. Truck 3 drives a daily route from point A to point B. The only alternative-fuel stations along the route are located at end-points, point A and point B. Because truck hauls change considerably depending on which way it's going, its one-way fuel consumption varies greatly and amounts to 0.7× to 1.3× that of an alternative fuel capacity. With average fuel consumption being close to 1× that of an alternative-fuel capacity, prior art system and methods would lead to incorrect input parameters for a feasibility evaluation to a switch to alternative fuel.

Consider the case of complex alternative-fuel fueling-infrastructure along a route. Truck 4 drives a regular long-haul route from the East Coast to the West Coast. Because alternative-fuel fueling infrastructure along the route is sparse, potential alternative-fuel utilization rate is significantly below 100%, thus negatively impacting viability of a switch to alternative fuel.

Consider the case of route optimization. Truck 5 drives a regular long-haul route from the East Coast to the West Coast. Because alternative-fuel fueling infrastructure along the route is sparse, potential alternative fuel utilization rate is significantly below 100%, thus negatively impacting the viability of a switch to alternative fuel. An algorithm evaluates alternative routes for Truck 5 and finds a slightly longer route that will result in slightly higher fuel consumption, but also leads to a higher alternative-fuel utilization rate and overall lower fuel-costs.

Consider the case of fill infrastructure. Truck 6 belongs to a large company and, along with other trucks from the company, drives a regular long-haul route from the East Coast to the West Coast. Because alternative-fuel fueling infrastructure along the route is sparse, potential alternative fuel utilization rate is significantly below 100%, thus negatively impacting the viability of a switch to alternative fuel. An algorithm evaluates alternate routes and alternative fueling infrastructure along those alternate routes and determines that a fueling station may need to be built along one of the routes.

FIG. 4 is a block diagram of an example system for tracking and estimating alternative fuel benefits in a fleet of vehicles or optimizing alternative-fueling infrastructure using an embodiment of the present invention. In particular, it shows an implementation of the present invention (for example, shown in FIG. 3) using web services technology.

API Gateway 450 can receive geospatial data from one or more vehicles. API Gateway 450 can implement a standard API or a unique API created by administrators of the application. The geospatial data can be passed onto Computing Service 410 and stored in Cloud Database 420 (e.g., data stored in data warehouses 210, 220). Computing Service 410 can compile and organize the geospatial data.

Data Warehouse and Processing Center 400 can receive the data stored in Cloud Database 420 and can perform calculations involving other data sets, such as fuel consumption calculations or alternative-fuel equipment optimization. Data Warehouse and Processing Center 400 can serve as a data warehouse for data used in tracking and estimating alternative fuel benefits in a fleet of vehicles or optimizing alternative-fueling infrastructure.

Cloud Computing Service 430 can store three Computing Instances 432, 434, and 436 (e.g., virtual machines, etc.). In one example, Computing Instance 432 can evaluate and optimize routes, Computing Instance 434 can make alternative-fuel recommendations, and Computing Instance 436 can conduct alternative-fuel benefits analysis based on data received from Data Warehouse and Processing Center 400. Outputs from the Computing Instances can be passed on to Email Service 440 and/or to Relational Database 480.

Relational Database 480 can interact with Cloud Computing Service 411 to perform calculations, for example fuel consumption calculations and alternative-fuel equipment optimization. Relational Database 480 can contain a subset of data from the Data Warehouse, for example, data relevant to the current calculations. Relational Database 480 can also receive data via Cloud Computing Service 411 and API Gateway 451, which can receive data from Operator's Web Application 470.

Email Service 440 can send emails to Operator's Web Application 470 for notifications, alerts or transactional purposes. Email Service 440 can update Operator's Web Application 470 about recent recommendations made by Cloud Computing Service 430, or send benefits analyses, route updates, etc. Domain Name System 460 can provide the domain name for Operator's Web Application 470.

Cloud Computing Service 431 can request and receive data from Relational Database 480, and can forward this data to Cloud Database 420 or to third parties. This post-analysis data can be fed into Cloud Database 420 and combined with vehicle geospatial data before being sent to Data Warehouse and Processing Center 400. In other instances, the data is not combined and send separately.

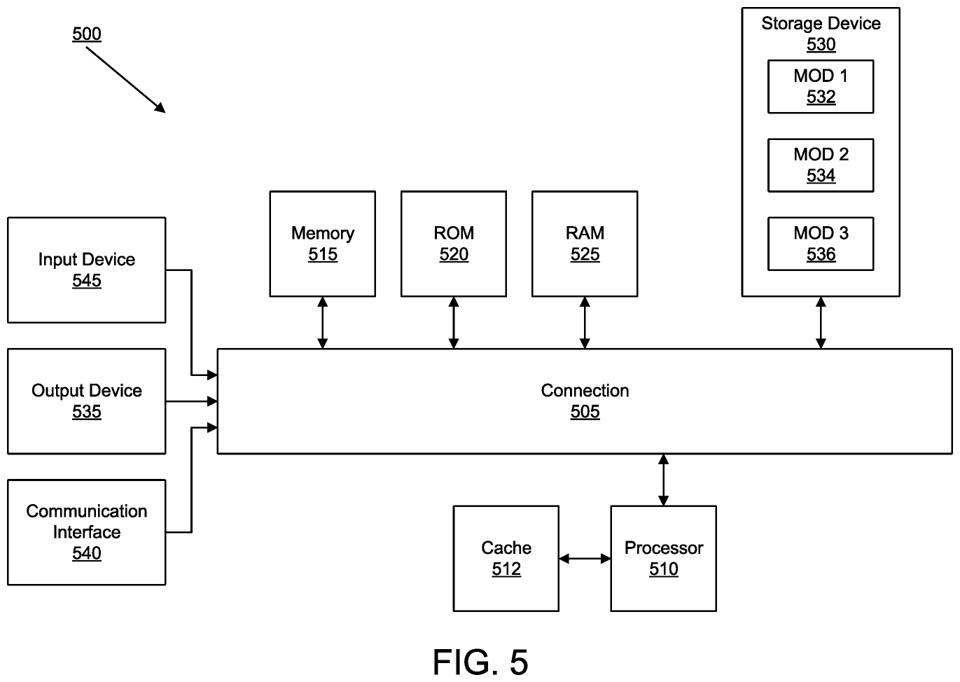

FIG. 5 illustrates an example computing system architecture 500 including components in electrical communication with each other using a connection 505, such as a bus, upon which one or more aspects of the present disclosure can be implemented. System 500 includes a processing unit (CPU or processor) 510 and a system connection 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware or software service, such as service 1 532, service 2 534, and service 3 536 stored in storage device 530, configured to control the processor 510 as well as a special-purpose processor where software instructions are incorporated into the actual processor design. The processor 510 may be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include services 532, 534, 536 for controlling the processor 510. Other hardware or software modules are contemplated. The storage device 530 can be connected to the system connection 505. In one aspect, a hardware module that performs a particular function can include the software component stored in a computer-readable medium in connection with the necessary hardware components, such as the processor 510, connection 505, output device 535, and so forth, to carry out the function.

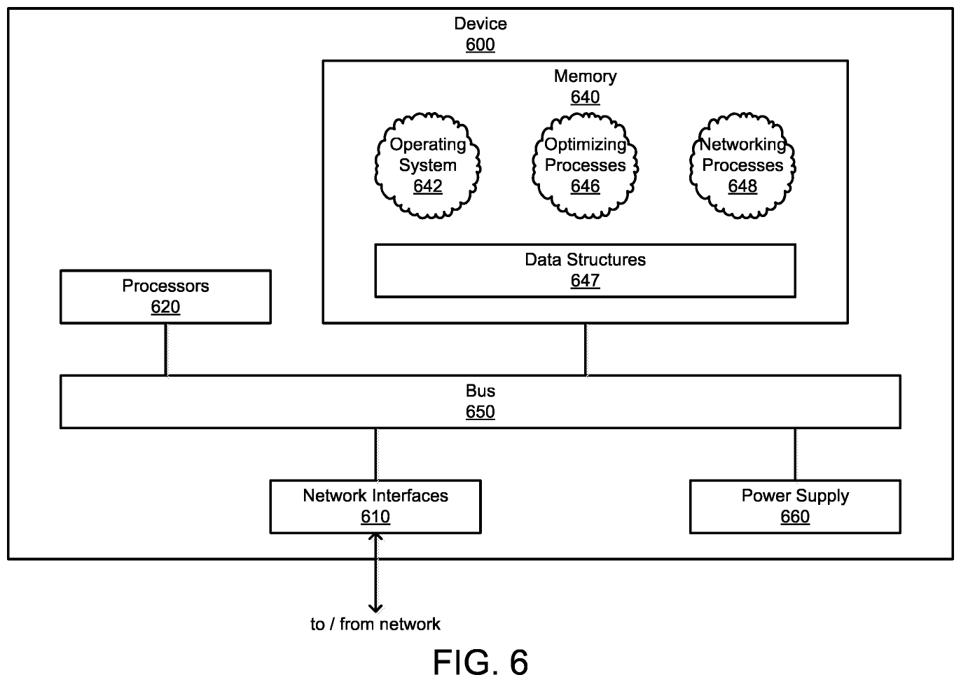

FIG. 6 is a schematic block diagram of an example computing Device 600 that may be used with one or more embodiments described herein e.g., as any of the discussed above or to perform any of the methods discussed above, and particularly as specific devices as described further below. The device may comprise one or more Network Interfaces 610 (e.g., wired, wireless, etc.), at least one Processor 620, and a Memory 640 interconnected by a system Bus 650, as well as a Power Supply 660 (e.g., battery, plug-in, etc.).

Network Interface(s) 610 contain the mechanical, electrical, and signaling circuitry for communicating data over links coupled to a network, e.g., providing a data connection between Device 600 and the data network, such as the Internet. The network interfaces may be configured to transmit and/or receive data using a variety of different communication protocols. For example, Interfaces 610 may include wired transceivers, wireless transceivers, cellular transceivers, or the like, each to allow device 600 to communicate information to and from a remote computing device or server over an appropriate network. The same Network Interfaces 610 also allow communities of multiple devices 600 to interconnect among themselves, either peer-to-peer, or up and down a hierarchy. Note, further, that the nodes may have two different types of network connections, e.g., wireless and wired/physical connections, and that the view herein is merely for illustration. Also, while the Network Interface 610 is shown separately from Power Supply 660, for devices using powerline communication (PLC) or Power over Ethernet (PoE), the Network Interface 610 may communicate through the power supply 660, or may be an integral component of the power supply.

Memory 640 comprises a plurality of storage locations that are addressable by the Processor 620 and the Network Interfaces 610 for storing software programs and data structures associated with the embodiments described herein. The Processor 620 may comprise hardware elements or hardware logic adapted to execute the software programs and manipulate the Data Structures 647. An Operating System 642, portions of which are typically resident in Memory 640 and executed by the processor, functionally organizes the device by, among other things, invoking operations in support of software processes and/or services executing on the device. These software processes and/or services may comprise one or more Optimizing Processes 646 which, on certain devices, may be used by an illustrative Networking Process 648, as described herein. Notably, Optimizing Processes 646 may be stored and/or retrieved for storage by Processor(s) 620 via, for example, Network Interface(s) 610 or other processes according to the configuration of Device 600.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for tracking and estimating alternative fuel benefits, the method comprising:
receiving, from at least one alternative fuel capable vehicle, a set of vehicle-specific data;
aggregating the at least one set of vehicle-specific data into a fleet dataset;
receiving a traditional fuel dataset, an alternative fuel dataset, a conversion dataset, and auxiliary datasets;
optimizing, using the fleet dataset, the traditional fuel dataset, the alternative fuel dataset, the conversion dataset, and auxiliary datasets, fuel consumption practices for the at least one alternative fuel capable vehicle, the fuel consumption practices comprising one or more of vehicle routes, vehicle conversions, or fueling stops; and
recommending the optimized fuel consumption practices.

2. The method of claim 1, wherein the fleet dataset comprises vehicle geospatial data, speed, engine status, fuel consumption, engine type, fuel type, vehicle brand, or mileage, the traditional fuel dataset comprises geospatial data of traditional fueling stations, historical traditional fuel costs, or traditional fuel efficiency, the alternative fuel dataset comprises geospatial data of alternative fueling stations, historical alternative fuel costs, or alternative fuel efficiency, the conversion dataset comprises outfitter conversion costs associated with various alternative fuel types, manufacturer costs associated with various alternative fuel types, or fuel tank sizes, and the auxiliary datasets comprises customer-specific data, location-specific data, fuel price projections, or weather data.

3. The method of claim 1, wherein the optimizing the fuel consumption practices further comprises optimizing for cost, alternative-fuel consumption, or mileage.

4. The method of claim 1, wherein recommending the fuel consumption practices further comprises:
displaying, via a graphical user interface, information contained in the fuel consumption practices for the at least one alternative fuel capable vehicle; and
interfacing with a geospatial mapping service to display vehicle routes and fueling stops contained in the fueling consumption practices.

5. The method of claim 1, wherein receiving datasets further comprises sending a data request to a database using an API for the database.

6. The method of claim 1, wherein optimizing the fuel consumption practices further comprises:
feeding the fleet dataset, the traditional fuel dataset, the alternative fuel dataset, the conversion dataset, and the auxiliary dataset into an optimization algorithm; and
generating, via the optimization algorithm, optimized fuel consumption practices for one or more of each of the at least one alternative fuel capable vehicles or for a fleet comprising the at least one alternative fuel capable vehicles.

7. The method of claim 1, wherein optimizing the fuel consumption practices further comprises:
forecasting, using the fleet dataset, the traditional fuel dataset, the alternative fuel dataset, the conversion dataset, and the auxiliary dataset, projections of future fuel practice costs; and
using the projections of future fuel practice costs to optimize fuel consumption practices.

8. A system for tracking and estimating alternative fuel benefits, the system comprising:
at least one alternative-fuel capable vehicle;
a set of datasets including a fleet dataset, a traditional fuel dataset, an alternative fuel dataset, a conversion dataset, and auxiliary datasets;
an optimization service which optimizes fuel consumption practices for the at least one alternative-fuel capable vehicle using at least a portion of the set of datasets, the fuel consumption practices comprising vehicle routes, vehicle conversions, or fueling stops.

9. The system of claim 8, wherein the fleet dataset comprises vehicle geospatial data, speed, engine status, fuel consumption, engine type, fuel type, vehicle brand, or mileage, the traditional fuel dataset comprises geospatial data of traditional fueling stations, historical traditional fuel costs, or traditional fuel efficiency, the alternative fuel dataset comprises geospatial data of alternative fueling stations, historical alternative fuel costs, or alternative fuel efficiency, the conversion dataset comprises outfitter conversion costs associated with various alternative fuel types, manufacturer costs associated with various alternative fuel types, or fuel tank sizes, and the auxiliary datasets comprises customer-specific data, location-specific data, fuel price projections, or weather data.

10. The system of claim 8, wherein the optimization service optimizes for one or more of cost, alternative-fuel consumption, or mileage.

11. The system of claim 8, further comprising a graphical user interface configured to display information contained in the fuel consumption practices for the at least one alternative fuel capable vehicle and to interface with a geospatial mapping service to display vehicle routes and fueling stops contained in the fueling consumption practices.

12. The system of claim 8, wherein the optimization service is configured to send a data request to a database using an API for the database, and to receive a response from the database.

13. The system of claim 8, wherein the optimization service is configured to:
feed the fleet dataset, the traditional fuel dataset, the alternative fuel dataset, the conversion dataset, and the auxiliary dataset into an optimization algorithm; and
generate, via the optimization algorithm, optimized fuel consumption practices for one or more of each of the at least one alternative fuel capable vehicles or for a fleet comprising the at least one alternative fuel capable vehicles.

14. The system of claim 8, wherein the optimization service is configured to:
forecast, using the fleet dataset, the traditional fuel dataset, the alternative fuel dataset, the conversion dataset, and the auxiliary dataset, projections of future fuel practice costs; and
use the projections of future fuel practice costs to optimize fuel consumption practices.

15. A non-transitory computer readable medium comprising instructions stored thereon, the instructions are effective to cause at least one processor to:
receive, from at least one alternative fuel capable vehicle, a set of vehicle-specific data;
aggregate the at least one set of vehicle-specific data into a fleet dataset;
receive a traditional fuel dataset, an alternative fuel dataset, a conversion dataset, and auxiliary datasets;
optimize, using the fleet dataset, the traditional fuel dataset, the alternative fuel dataset, the conversion dataset, and auxiliary datasets, fuel consumption practices for the at least one alternative fuel capable vehicle, the fuel consumption practices comprising vehicle routes, vehicle conversions, or fueling stops; and
recommend the optimized fuel consumption practices.

16. The non-transitory computer readable medium of claim 15, wherein the instructions to optimize the fuel consumption practices comprise optimizing for cost, alternative-fuel consumption, or mileage.

17. The non-transitory computer readable medium of claim 15, wherein the instructions are further effective to:
display, via a graphical user interface, information contained in the fuel consumption practices for the at least one alternative fuel capable vehicle; and
interface with a geospatial mapping service to display vehicle routes and fueling stops contained in the fueling consumption practices.

18. The non-transitory computer readable medium of claim 15, wherein the instructions are further effective to send a data request to a database using an API for the database.

19. The non-transitory computer readable medium of claim 15, wherein the instructions are further effective to:
feed the fleet dataset, the traditional fuel dataset, the alternative fuel dataset, the conversion dataset, and the auxiliary dataset into an optimization algorithm; and
generate, via the optimization algorithm, optimized fuel consumption practices for one ore more of each of the at least one alternative fuel capable vehicles or for a fleet comprising the at least one alternative fuel capable vehicles.

20. The non-transitory computer readable medium of claim 15, wherein the instructions are further effective to:
forecast, using the fleet dataset, the traditional fuel dataset, the alternative fuel dataset, the conversion dataset, and the auxiliary dataset, projections of future fuel practice costs; and
use the projections of future fuel practice costs to optimize fuel consumption practices.
